(19) United States
(12) Patent Application Publication
(10) Pub. No.: US 2004/0034637 A1
(43) Pub. Date: Feb. 19, 2004

(54) Accessing a set of local or distant resources

(76) Inventors: Stephanie Riche, Grenoble (FR); Eric Raffaele, Toulouse (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/373,203

(22) Filed: Feb. 26, 2003

(30) Foreign Application Priority Data
Feb. 26, 2002 (EP) 02354036.2

(51) Int. Cl. G06F 17/30

(52) U.S. Cl. 707/9

(57) ABSTRACT

A set of resources is accessed via a browser of a computer by procuring a bookmark database including a set of bookmark files, each of which is associated with a URI identifying a resource and includes a description of a set of context items. The context of use of the computer is monitored. The current context file having a set of context items is correspondingly updated. From the contents of the current context file, a subset of the bookmark database is computed to derive a subset of bookmarks having a higher relevance to the user. The subset of bookmarks is displayed by the browser.

### TECHNICAL FIELD OF THE INVENTION

The invention relates to communication systems and more particularly to a process of accessing local or distance resources through an Internet or Intranet network and to a memory storing a program for enabling a computer to perform the process and to a computer system for performing the process.

### BACKGROUND ART

The constant progress of Information Handling System (IHS) technology and that of telecommunication systems, particularly with the explosion of the Internet and Intranet networks, has considerably increased the amount of information and the number of service providers which are available to the user.

The personalization of the access to such a huge number of resources is proving essential to enable efficient use of the Internet.

Solutions have been developed in the art for making it easier to access this huge amount of resources and for improving the possibilities of negotiation and new services. For this purpose, agents have been proposed for allowing the users to delegate some specific tasks to automatic modules in order to simplify part of the searching process.

U.S. Pat. No. 5,877,759 assigned to Netscape Communications Corp. and entitled Interface for user/agent interaction discloses a first example of a user interface which provides assistance to the client user and an interface that is centered on autonomous processing of whole tasks rather than sequences of commands.

WO 98/47250 application assigned to IBM Corp. and entitled Apparatus and method for communicating between an intelligent agent and client computer process using disguised messages discloses an agent for communicating with a client and which uses a selector known by both parties to generate and interpret messages and thereby to effectively disguise confidential information transmitted in the message from third parties.

WO 98/43146 application assigned to IBM Corp., and entitled Intelligent agent with negotiation capability and method of negotiation therewith is another example of an improvement brought to a so-called intelligent agent.

The use of one or more profile files located within a user's computer is a very promising field of development. A profile file is more easily updated since the user feels more concerned about the information which he loads into his own profile file(s). Further this information continuously remains under his/her own control. When the user permits it, the use of the information loaded into that or those profiles is of the highest interest for service providers since it can be used to enhance the personalization and the possibilities for negotiation with the user. Practically, the profile files can be used by product/service providers who wish to propose an offer well tailored to the user's needs. EP-A-118949 describes an example of an efficient use of a profile file by an agent. The agent extracts, from an abstract request made by the user, a complex request which can be transmitted to a web server for further processing and negotiation.

In addition to the use of agents or profile files, the personalization of the access to the Internet network can also benefit from a bookmarking facility provided by web browsers. By giving each user the possibility of bookmarking the Uniform Resource Identifier (URI) of a given web page, every user can build a personalized set of hierarchically arranged addresses for reaching, in a fast and convenient manner, his/her preferred web pages or other local or distant resources. It will be understood that URI is the generic term for all types of names and addresses that refer to objects on the World Wide Web. A URL (Universal Resource Locator) of a web page is one kind of URI.

Although the personalization and the access to the resources of the Internet network are greatly facilitated by known bookmarking techniques, their usefulness diminishes as the number of bookmarks increases.

Indeed, beyond a certain size, the user has to organize its set of bookmarks in a more or less sophisticated hierarchy for the purpose of retrieving one particular item when he/she wishes to do so. The retrieval process for recording each individual bookmark can become time-consuming and, in any case, the success of the retrieval closely depends upon the ability of the user to be able to recall the location where the user registered the one particular bookmark he/she is looking for. Should the lafter escape the user's memory, then the usefulness of the bookmark will be lost.

Thus, there remains a need for techniques which allow easier personalization of the browser and further facilitate the retrieval of individual bookmarks when a user is browsing.

It is an object of the present invention to provide a new and improved process for facilitating the access to the information available on a network, such as the Internet network, by using an enhanced bookmarking technique.

### SUMMARY OF THE INVENTION

In accordance with one aspect of the invention, access via a browser to a set of local or distant resources, such as web servers (wherein the resources are defined by corresponding URI), is obtained with the aid of a context engine, which is typically in a personal computer of a user. The engine accesses a bookmark database including a set of bookmark files, each bookmark file being associated with a given URI. Each bookmark file further comprises a description of a predefined set of fields or context items that are associated with corresponding events. Context items are associated, typically, by hardware resources of the user's computer, to a particular document which is opened by the user in a given application software program. The document is typically a current web page being displayed to the user. The document can more generally be any kind of event or state which can be monitored within the computer and reported back to the context engine. Once the context engine is informed of the occurrence of an event change (typically a context change), the engine controls the update of a current context file and correspondingly amends the corresponding context item.

During the web surfing process, the context engine compares the current context tracked within a current context file with the contents of the different bookmark files loaded in the bookmark database for the purpose of deriving and computing an ordered list of the bookmarks or one or more sublists of said bookmarks which are more relevant in view of the current context. Once computed, the process displays the contextual bookmarks to the user for selection or actuation within the web browser.

Preferably, the bookmark files are associated with a set of context items, which are assigned a weighting value for the purpose of allowing an ordering process of the different bookmarks. Therefore, when the user is browsing, in accordance with the actual context of the computer, the browser presents an ordered set of bookmarks.

Preferably, the process of creating a bookmark includes the steps of:

(1) detecting a bookmarking request by the user;

(2) reading the contents of the current context file; and

(3) creating a bookmark file associated with said URI by using the contents derived from the contents of said current context file.

The context engine can then derive from the bookmark files an ordered list of bookmarks which is computed in accordance with the contents of said current context file and used for generating a contextual bookmark feature.

In one embodiment, at the creation of the bookmark file, each context item is assigned a particular numerical default weight value which is used for the purpose of ordering the different bookmarks in accordance with the context of use of the computer.

In one embodiment, there is provided a process of automatically flagging a page being displayed within a web browser, said process including the steps of:

(1) creating and maintaining a current context file including a description of a set of context items which is being monitored;

(2) creating, in response to the user flagging one current web page being displayed, a bookmark file which comprises a copy or a sublist of the elements existing within said current context file; and

(3) automatically controlling the display of said flagged bookmark in response to the context monitored within said current context file being close to the description existing in said bookmark file.

More generally the invention provides a technique of creating bookmarks attached with context information so that bookmarked information is easily retrieved when the user is in a similar context. The information can be stored so that useful bookmarks can be retrieved even a long time after the bookmarking action.

Another aspect of the invention relates to a memory storing a computer program having program code elements for enabling a computer to perform the above described processes and to a computer system for performing the process.

### BRIEF DESCRIPTION OF THE DRAWING

An embodiment of the invention will now be described, by way of example only, with reference to the accompanying drawings, wherein:

FIG. 1 is a block diagram of the basic architecture of a computer having improved browsing and bookmarking capabilities;

FIG. 2 is a flow diagram of a process (executed by the computer of FIG. 1) of creating a bookmark within a database;

FIG. 3 is a flow diagram of a process (executed by the computer of FIG. 1) of updating the weighting of the different context items associated with one given URL;

FIG. 4 is a flow diagram of the process (executed by the computer of FIG. 1) of displaying a web page within the web browser; and

FIG. 5 is a flow diagram of the process (executed by the computer of FIG. 1) of updating the context file.

### DETAILED DESCRIPTION OF THE DRAWING

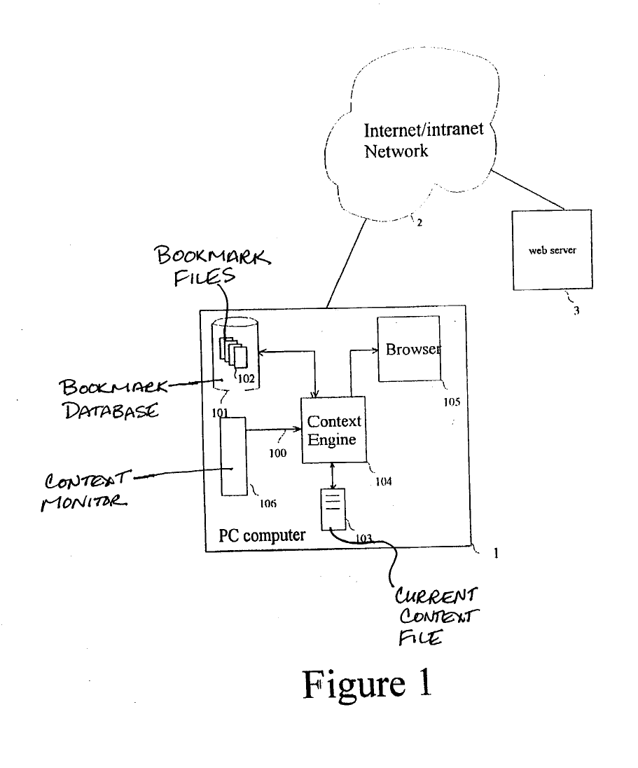

FIG. 1 is a block diagram of the basic architecture of a computer 1 which is fitted with a browser having improved contextual bookmarking capabilities. In the following description, the term bookmark refers to a general URI, which is, for instance, a URL of a given web page.

Computer 1 is fitted with communication resources allowing the computer to access a web server 3 through an Internet or Intranet network 2. A web browser 105 such as, for instance, Internet Explorer 4 (manufactured by Microsoft Corp.) or Netscape Navigator (manufactured by Netscape Communications Corp.), handles the communication through the standard Hyper Text Transfer Protocol (HTTP). These browsers generally permit extensions to be implemented by an appropriate development toolkit providing access to the Application Programming Interface (API). It will be understood that such extensions can be used for the purpose of embodying the contextual browsing process which is described below and for carrying out an enhanced browser.

In the preferred embodiment, the computer 1 includes a bookmark database 101 which comprise bookmark files 102, each of which is associated with one particular URL defining one local or distant resource. Each bookmark file 102 is created by a context engine 104 upon a request from a user to bookmark a given URL when the latter is surfing with their browser. File 102 includes a description of a given context arranged in a set of so-called context items. Preferably, each bookmark file 102 is embodied in the form of eXtensible Mark-up Language (XML) code including a description of a set of context items; of course, the use of XML for embodying the bookmark files is only a matter of choice. Any other suitable format could equally be used.

In the following, the term “context” refers to the particular background mode and environment of the computer and the user (if profile information is available) at a given time. More precisely, the context can be defined using many separate and different aspects and elements, which are hereinafter referred to as individual context items defining a particular aspect of the background mode of operation of the computer associated with one particular event, and the whole set of context items defines the global environment or context of use of the computer.

In one embodiment, one particular context item indicates whether the computer is operated from the user's office or, in the case of a laptop computer, from her/his home.

In another embodiment, one particular context item is associated with the particular physical location of the computer, such as provided, for instance, by a suitably arranged Global Positioning System (GPS) sensing device.

In another embodiment, one particular context item is associated with the particular application software which is launched or being used by the user within the computer, and/or the particular files which are used by said application software program.

A further context item is associated with the particular bookmark which is accessed by the user through his/her web browser.

A further context item is based on the last word that was the subject of a search statement by the user of the operating system or in a given application program.

The context items which are described above are only examples of possible embodiments of the contextual bookmarking technique. However, it should be clear that the invention is not limited to those examples; many other similar parameters could equally be used.

Computer 1 is fitted with an appropriate context item monitoring element 106 which monitors the occurrence of a particular event associated with a given context item and, correspondingly, reports this information to context engine 104 via an appropriate communication link 100 which is based on a notification of event changes. If specific software is involved for retrieving the information relating to the event changes, such as for retrieving GPS coordinates, the communication between this specific software and element 106 is based, for instance, on an Inter Process Communication (IPC) channel, the operation of which is generally well known.

Context item monitoring element 106 can vary to a large extent in accordance with the particular context items which are used. In one embodiment, element 106 uses the determination of the Internet Protocol (IP) address assigned to the computer to detect whether the computer (if, for instance, it is a laptop computer) is being used at the user's office or at home. Indeed, when connected, the computer is assigned an IP address belonging to different ranges in accordance with the particular Internet Service Provider (ISP) providing the connection to the Internet network.

In another embodiment, context item monitoring element 106 communicates with a Global Positioning System (GPS) sensing device (not shown) for the purpose of reporting to context engine 104 the precise physical location of the computer.

For the particular case where the computer 1 is operated under the well-known Windows 9× or Windows 2000 operating systems marketed by Microsoft, context item monitoring element 106 includes a set of instructions for accessing the internal registry to determine which particular application programs (and within said programs, which particular document or electronic files) are currently open and/or being used by the user.

In accordance with the various data reported through communication link 100, context engine 104 updates the contents of current context file 103, and more particularly the context item corresponding to a particular event or change reported. Current context file 103 can be embodied in different ways and, particularly in the registry used by the operating system of computer 1. Alternatively, current context file 103 can comply with the known XML standard defined by the World Wide Web Consortium (W3C) and which is associated with a Document Type Definition (DTD) file. The DTD file defines the rules for how the elements, attributes, and other data in an XML-encoded profile are defined and logically related. In one embodiment, the XML current context file 103 recites the different context items available in the machine, and a supplementary flag representative of the activation of the latter.

Below is provided a typical example of the contents of current context file 103 based on an XML structure. The contents of current context file 103 in this example comprise, among others, a first context item referring to the location where the user is physically located, a second context item which refers to the the background application and the associated files that are open etc.

<TableOfContext>

<Location>work</Location>
<BackgroundApp>

<app name= “Microsoft Word” >

<document>Specification.doc</document>

<app>
<app name= “Borland JBuilder” >

<document>aClass.java</document>
<document>anotherClass.java</document>

<app>
<app name= “Internet explorer” >

<document>aNetRadio.com</document>
<document>www.athp.com</document>

<app>

</BackgroundApp>

</TableOfContext>

Clearly, the particular current context file 103 can be adapted to match particular requirements or needs.

Similarly to the XML structure described below, every bookmark file 102 also comprises a description of the context items which are associated with one given web page, or more generally to one given bookmark. In one embodiment, each context item in file 102 is further assigned a particular digital value which is used as a weight for the purpose of allowing computation possibilities of the different bookmark files, and more particularly the relevance of those different bookmark files with respect to a given context for the purpose of computing an ordered list of bookmarks in view of a given context.

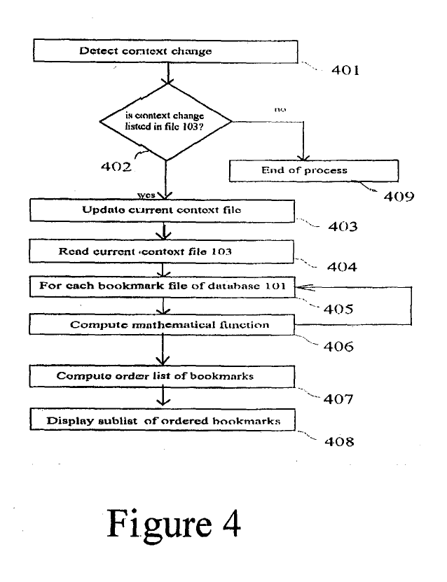

The bookmark files 102 are created and maintained by context engine 104 which receives and processes the information conveyed through communication channel 100. Engine 104 interfaces with browser 105 to provide access to the Internet network, or an Intranet network for instance. In the preferred embodiment, a graphical user interface (GUI) of browser 105 is enriched, via an appropriate development tool that can, for instance, be offered by the browser manufacturer as explained above, with an additional toolbar which provides for the display of a set of contextual bookmarks which are automatically displayed in accordance with the process which is described hereinafter with reference to FIG. 4.

There are now described the particular processes which (1) create and maintain the bookmark files 102 of bookmark database 101 and (2) use bookmark files 102 for controlling the displaying within browser 105 of a contextual set of bookmarks.

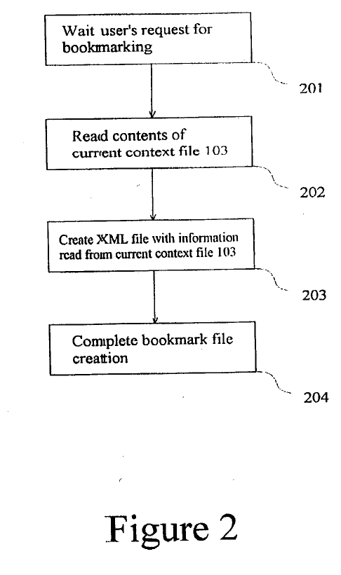

FIG. 2 is a flow diagram of a program that computer 1 stores to create one bookmark file in database 101 in response to a user request being supplied to the computer.

The bookmark creation process starts with step 201 during which context engine 104 waits for a user's request to bookmark a given web page which is currently displayed by web browser 105. In one embodiment, the detection is achieved by a specific menu item appearing in a menu toolbar of the browser.

In response to browser 105 detecting a bookmarking request from the user, the context engine 104 reads the contents of the current context file 103 in step 202.

Then in step 203, the context engine 104 creates an XML file which is associated with the web page or other resource corresponding to the considered URL or URI and to the name of that page (provided by the page itself by default), and writes within said new XML file the contents of the information read from the current context file 103. In addition, context engine 104 assigns to each context item referred to within said XML file a numerical value corresponding to a given predefined weight. Alternatively, it should be understood that the way of assigning the weight to the particular context item being considered can be varied. For instance, assume, in one embodiment, that one particular application is launched and one particular document is opened. In such an example, the document is assigned a bookmark default weight of 100. Conversely, if the context is such that actually three different documents are opened for the same application program, the weight is set at 33 for each document.

An example of an XML structure which can be used for describing the context items and the weights assigned to the latter is:

<bookmark url=“www.javaside.com“ name=“site d'entraide pour java”>

<ContextSet>

<Location>

<aLocation name=work weight= 100/>

</Location>
<BackgroundApp>

</app name= “Microsoft Word” weight=33>
</app name= “Borland JBuilder” weight=33>
</app name= “Internet explorer” weight=33>

<IBackgroundApp>

</ContextSet>
</bookmark>

The bookmark creating process is completed in step 204.

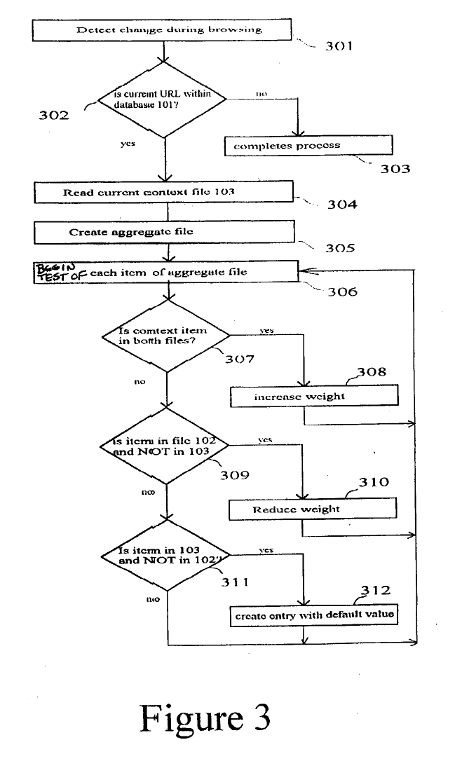

FIG. 3 is a flow diagram of operations the memory of computer 1 stores for causing the computer to update and modify the current weights assigned to the different context items arranged in a given bookmark file 102 in response to signals resulting from the user surfing the Internet, for instance, using web browser 105.

In step 301, the process starts by browser 105 detecting an event or change in one context item when the user is browsing.

In step 302, the processor of computer 1 determines whether the current URL displayed by the browser 105 corresponds to an XML file which is stored in the bookmark database 101.

If the current URL does not correspond to an XML file within the bookmark corresponding to the XML file database 101, the process is completed in step 303. Conversely, in response to the URL, the process proceeds to step 304 where the contents of the current context file 103 are read. Then, the processor program proceeds to step 305, during which the processor of computer 1 creates a temporary aggregate file including the context items existing in both the current context file 103 and the considered bookmark file 102 without any duplication.

The process then proceeds to a loop where each item of the temporary file created in step 305 is successively tested; the loop begins in step 306. For each context item considered, the process then proceeds to a set of three successive tests respectively performed in steps 307, 309 and 311.

In the first test, step 307, the processor of computer 1 determines if the considered context item is listed in both the current context file 103 and the bookmark file 102. If the result of step 307 is yes, i.e., the considered context is listed in files 102 and 103, the processor of computer 1 increases the weight assigned to said context item by a given value (step 308). The process then loops back to step 306 to test the next context item of the aggregate file.

If the result of step 307 is no, the processor performs a second test in step 309 to determine if the considered context item is listed in bookmark file 102 but is not present in current context file 103, in which case the processor decreases the assigned weight by a predefined number in step 310. The process then loops back to step 306 to test the next context item listed in the temporary file.

If the test of step 309 fails, the processor proceeds to step 311 to determine whether the context item is listed in current context file 103 but is not present in bookmark file 102, in which case an entry corresponding to the considered context item is created within bookmark file 102 and a default weighting value is established in step 312. The process then loops back to step 306 to test the next context item listed in the temporary file.

When the processor of computer 1 has processed all the context items, the process of FIG. 3 is completed. It will be observed that the basic functionality described above could be implemented using much more sophisticated techniques, based for instance, on the use of artificial intelligence.

FIG. 4 is a flow diagram of the program (i.e., process steps) the memory of computer 1 stores to cause the processor of computer 1 to continuously control the display of browser 105 for the purpose of providing a contextual bookmark display process.

In step 401, the processor of computer 1 detects the occurrence of a change in the context monitored by context monitor 106, as coupled via communication link 100 to context engine 104.

In step 402, context engine 104 determines if the detected context change is significant or listed within the current context file 103. If the context change is unlisted, the process of FIG. 4 is ended in step 409.

If the detected context change is significant or listed within the current context file 103, then the process proceeds to step 403 where the current context file is updated. Then, in step 404, the context engine 104 reads the current, updated context file 103.

Then, in step 405, the context engine 104 enters a loop during which each bookmark file 102 of bookmark database 101 is successively processed.

For each considered bookmark file 102, context engine 104 compares in step 406 the contents of the current context file 103 with the context items recited within the bookmark file 102 being currently processed in step 405. In response to this comparison, context engine 104 during step 406 computes a mathematical function of the different weights assigned to each item in accordance with the activation of said item reported within said current context file 103. The context engine 104 then produces a final result corresponding to the bookmark relevance factor which is representative of the convenience of said bookmark.

The process then proceeds back to step 405, at which time context engine 104 processes the next bookmark file 102.

When the weights for all the bookmark files 102 in database 101 have been computed, the process then advances to step 407 during which context engine 104 computes a list of bookmarks which are ordered in accordance with their computed weights. After all the bookmarks have been ordered, the processor advances to step 408, during which the display of the web browser 105 is activated to display the bookmarks in accordance with the bookmark weights.

It can be seen that the user is then automatically provided with a display of the web page he/she is interested in, and additionally is presented with the possibility of additional hyperlinks corresponding to alternate bookmarks which are contextually related to the web page of interest.

In one preferred embodiment, the context engine 104 responds to the results of the previously discussed computations to compute a subset of bookmarks contained within said bookmark files which are displayed to the user through the browser 105.

There is therefore provided a very effective contextual bookmarking facility which substantially enhances the personalization of the browser 105 and the possibility of accessing the information available through the Internet or Intranet network. Hereinafter there are provided some examples of such contextual environment, which are not limitative. For instance assuming that one user is developing a piece of software using the Java language, the user could be very interested in gathering some basic information and references relating to this particular topic. In this case, a useful context item could comprise the name of the development environment or application for creating the Java code, the version of the Java development tool, and possibly, the last word used by the user in a help menu. Therefore, if a user is working on the development of a Java piece of code, the context item could refer to the last Java instruction for which he/she requested some help, and to the development environment referring to Java.

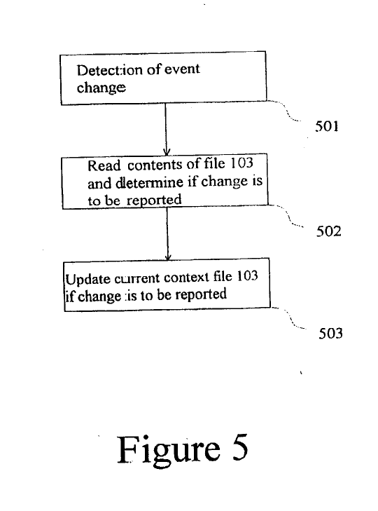

FIG. 5 is a flow diagram of a program the memory of computer 1 stores and executed for maintaining the current context file 103.

The process starts with step 501 during which the processor of computer 1 detects an event change. The detected event change can be varied in accordance with the particular requirements of the user. A typical event change is a change in the context monitored by context monitor 106, as coupled via communication link 100 to context engine 104 that detects the change.

In step 502, the process reads the contents of current context file 103 to determine if the current change is to be reported within said current context file 103.

If the event change corresponds to an item recited within the current context file 103, the corresponding item of the current context file 103 is updated in a step 503.

While the process which was described above is disclosed for an enhanced bookmarking technique allowing the user to improve the presentation of the bookmarks, it should be observed that the bookmark database 101 can also be used to create a special mechanism allowing the user to flag a particular page, without requiring any formal bookmarking. Such flagging operation automatically creates a corresponding bookmark file 102 associated with the particular URI or URL address. By continuously comparing the contents of current context file 103 and the different context items of the bookmark file 102, the process can automatically control the display of very ancient URLs or URIs which were once flagged by the user at a similar background or contextual environment.

1. A process of accessing a set of resources which can be accessed via a browser of a computer, said process comprising:
procuring a bookmark database including a set of bookmark files, each of said bookmark files being associated with a URI identifying a resource and including a description of a set of context items;
monitoring the context of use of said computer and correspondingly updating a current context file including a set of context items;
deriving a subset of bookmarks that are of higher relevance to the user by computing from the contents of said current context file a subset of said bookmark database; and
displaying said subset of bookmarks.

2. Process according to claim 1 further including creating a new bookmark by (a) detecting a bookmarking request for a URI; (b) reading the contents of the current context file; and (c) creating a bookmark file associated with said URI, the contents of the bookmark file being derived from the contents of said current context file.

3. Process according to claim 2 further including assigning a weight value to said bookmark file.

4. Process of claim 3 further including ordering bookmarks in accordance with the context of use of the computer in response to the assigned weight value.

5. Process according to claim 1 wherein said bookmark files are embodied in XML files comprising a set of context items.

6. Process according to claim 1 wherein one context item indicates physical location of said computer.

7. Process according to claim 6 further including distinguishing home and office use by using an IP address.

8. Process according to claim 1 wherein one context item indicates the particular position of the computer with respect to a physical location provided by a Global Positioning System sensing device.

9. Process according to claim 1 wherein one context item indicates at least one of (a) the particular application software programs that is open and (b) the particular documents or electronic files being used by said programs.

10. Process according to claim 1 wherein said displaying of said subset of bookmarks is carried out in response to the user clicking on a specific icon that differs from the icon providing the standard bookmark access.

11. Process of accessing a set of local or distant resources through an Internet or an Intranet network, said process comprising:
bookmarking a set of URL addresses;
creating a bookmark database including a set of bookmark files including a description of context items;
detecting the occurrence of specific events and reporting said events within a current context file;
computing from the contents of said current context file and from the contents of said bookmark files a subset of bookmarks determined as being of higher relevance; and
displaying said subset of computed bookmark as a contextual bookmark.

12. A process of controlling display of a web page corresponding to a URI, said process comprising the steps of:
creating a current context file including plural context items forming a general context;
continuously updating said current context file in accordance with a monitoring of additional context for the current file;
creating a bookmark file associated with said URI in response to a request from a user, the request causing flagging of one particular page being browsed;
storing within said bookmark file an indication that the context items are valid at the instant of flagging of said page; and
monitoring said current context file during a user browsing process.

13. Process of claim 12 further including displaying the flagged page to the user in response to the current context file having a context close to the description loaded within one flagged page.

14. A memory storing a program for enabling a computer user to access a set of resources via a browser, the memory storing signals for causing the computer to perform the steps of claim 1.

15. A memory storing a program for enabling a computer user to access a set of local or distant resources through an Internet or an Intranet network, the memory storing signals for causing the computer to perform the steps of claim 11.

16. A memory storing a program for controlling the display of a web page corresponding to a URI, the memory storing signals for causing the computer to perform the steps of claim 12.

17. A computer arrangement for enabling a computer user to access a set of resources via a browser, the computer being arranged for performing the steps of claim 1.

18. A computer arrangement for enabling a computer user to access a set of local or distant resources through an Internet or an Intranet network, the computer being arranged for performing the steps of claim 11.

19. A computer arrangement for controlling the display of a web page corresponding to a URI, the computer being arranged for performing the steps of claim 12.

20. The computer arrangement of claim 19 wherein the computer arrangement includes the display and the computer arrangement is arranged to cause the display to display the flagged page in response to the current context file having a context close to the description loaded within one flagged page.
